(19) United States
(12) Patent Application Publication
(10) Pub. No.: US 2002/0186622 A1
(43) Pub. Date: Dec. 12, 2002

(54) Analog electronic clock

(76) Inventor: Kenji Ogasawara, Chiba-shi (JP)

Correspondence Address: ADAMS & WILKS, 31st Floor, 50 Broadway, New York, NY, 10004, US

(21) Appl. No.: 10/158,357

(22) Filed: May 30, 2002

(30) Foreign Application Priority Data
Jun. 11, 2001 (JP) 2001-175691

(51) Int. Cl. G06F 1/04; G04F 5/00

(52) U.S. Cl. 368/157; 368/160

(57) ABSTRACT

It is an object to make it possible to drive a motor at a high speed without causing any shift in the position of a hand. A memory stores a count value representing a target position to which a hand is to move; a rotation detecting circuit detects that a motor has rotated to output a rotation detection pulse signal and detects that the motor has not rotated to output a non-rotation detection pulse signal; a hand position counter counts the rotation detection pulse signal; and a control circuit controls the rotation of the motor with a normal pulse until the count value stored in the memory and the value counted by the hand position counter agree with each other. When a non-rotation counter counts a predetermined number of consecutive non-rotation detection pulse signals, the control circuit drives the motor with a corrective driving pulse having a great pulse width.

### BACKGROUND OF THE INVENTION

1. Field of the Invention

The present invention relates to an analog electronic clock in which the rotation of a motor for driving a hand is controlled by a driving pulse supplied from motor control means and in which the hand is driven for rotation by the motor.

2. Description of the Prior Art

Analog electronic clocks have been conventionally used including chronographs in which the rotation of a motor for driving a hand is controlled by a driving pulse supplied from motor control means and in which the hand is driven for rotation by the motor. The analog electronic clocks may be used in such a manner that a hand (a second hand, hour hand or minute hand) is driven at a high speed to be moved to a predetermined position. For example, a hand may be driven at a high speed in some cases including a case in which a second hand of a chronograph is returned to the position of zero hour and a case in which a hand is moved to the position to indicate the current time after stopping the hand temporarily. In this case, the number of driving pulses supplied to the motor is counted to control the hand such that it accurately moves to a predetermined position to which it is to move.

However, in the conventional analog electronic clocks, since driving pulses supplied to the motor are counted to control the position of a hand, a problem arises in that a shift of the hand position is caused by a mismatch between the number of the driving pulses supplied to the motor and the quantity of rotation of the motor when the motor does not rotate for some reason.

Further, a normal driving pulse having a small pulse width is used to control high speed rotation of the motor, and the driving of the motor may not be controlled reliably. Therefore, there is a demand for a capability of controlling the rotation of the motor reliably with no positional shift of a hand using the driving pulse having a small width.

An approach to this is to drive the motor with a corrective driving pulse having a width greater than that of the normal driving pulse when driving cannot be achieved with the normal driving pulse having a predetermined pulse width (for example, see Japanese Patent Publication No. 18148/1988 and Japanese Patent Publication No. 18149/1988).

However, according to this approach, since a motor is driven with a corrective driving pulse any time when the motor is not driven with a normal driving pulse, the driving is performed with the corrective driving pulse even when the motor can be rotated by driving it with the normal driving pulse again. Therefore, since driving is frequently performed with the corrective driving pulse when the driving of the motor with the normal driving pulse frequently fails, a problem arises in that high speed driving becomes difficult to achieve because of a long driving period of the motor.

### SUMMARY OF THE INVENTION

It is an object of the invention to allow a motor to be driven at a high speed without causing any shift in the position of a hand.

According to the invention, there is provided an analog electronic clock in which the rotation of a motor for driving a hand is controlled by supplying a driving pulse to the motor from motor control means and in which the hand is driven for rotation by the motor, characterized in that the motor control means has storage means for storing a count value representing a target position to which the hand is to move, detection means for outputting a rotation detection pulse signal each time the rotation of the motor caused by the driving pulse is detected, first counting means for counting the rotation detection pulse signal and judging means for judging whether the count value stored in the storage means and the value counted by the first counting means have agreed with each other or not and in that the rotation of the motor is controlled by supplying the driving pulse to the motor until the count value stored in the storage means and the value counted by the first counting means agree with each other.

A configuration may be employed in which the detection means further outputs a non-rotation detection pulse signal each time it is detected that the motor is not rotated by the driving pulse, and the motor control means has second counting means which counts the non-rotation detection pulse and whose count value is reset each time the detection means detects the rotation of the motor and in which when the value counted by the second counting means reaches a predetermined value, the control means controls the rotation of the motor by supplying the motor with a corrective driving pulse having a width greater than a pulse width of a driving pulse which has been supplied until that point in time.

According to the invention, there is provided an analog electronic clock in which the rotation of a motor for driving a hand is controlled by supplying a driving pulse to the motor from motor control means and in which the hand is driven for rotation by the motor, characterized in that the motor control means has first storage means for storing a count value representing a target position to which the hand is move, detection means for outputting a rotation detection pulse signal each time the rotation of the motor caused by the driving pulse is detected and outputting a non-rotation detection pulse signal each time it is detected that the motor is not rotated by the driving pulse, first counting means for counting the rotation detection pulse signal, second counting means which counts the non-rotation detection pulse signals and whose count value is reset each time the detection means detects the rotation of the motor, judging means for judging whether the count value stored in the first storage means and the value counted by the first counting means have agreed with each other or not and second storage means for storing the value counted by the first counting means when the value counted by the second counting means reaches a predetermined value, in that when the value counted by the first counting means and the count value stored in the second storage means agree with each other, a corrective driving pulse having a width greater than a pulse width of a driving pulse which has been supplied until that point in time is supplied to the motor to control the rotation of the motor and in that the driving of the motor is stopped when the judging means judges that the count value stored in the first storage means and the value counted by the first counting means have agreed with each other. When the value counted by the first counting means and the count value stored in the second storage means have agreed with each other, the motor control means supplies the corrective driving pulse having a width greater than the pulse width of the driving pulse which has been supplied until that point in time to the motor to control the rotation of the motor and stops driving the motor when then judging means judges that the count value stored in the first storage means and the value counted by the first counting means have agreed with each other.

A configuration may be employed in which there is provided initialization instruction means for instructing initialization at predetermined timing, in which the motor control means has pulse width initializing means for initializing the driving pulse to an initial driving pulse having a predetermined pulse width in response to the initialization instruction and in which the rotation of the motor is controlled by supplying the initial driving pulse to the motor in response to the initialization instruction.

Another configuration may be employed in which there is provided an operating section and in which the motor control means supplies a driving pulse to the motor to control the rotation of the motor until the count value stored in the first storage means and the value counted by the first counting means agree with each other in response to an operation on the operating section.

Another configuration may be employed in which there is provided an operating section and in which the motor control means supplies a driving pulse for reversing the motor to control the rotation of the motor until the count value stored in the first storage means and the value counted by the first counting means agree with each other in response to an operation on the operating section.

### BRIEF DESCRIPTION OF THE SEVERAL VIEWS OF THE DRAWINGS

A preferred form of the present invention is illustrated in the accompanying drawings in which:

FIG. 1 is a block diagram of an analog electronic clock according to a mode for carrying out the invention;

FIG. 2 is a flow chart showing a process in the analog electronic clock according to the mode for carrying out the invention;

FIG. 3 is a flow chart showing a process in the analog electronic clock according to the mode for carrying out the invention;

FIG. 4 is a flow chart showing a process in the analog electronic clock according to the mode for carrying out the invention;

FIG. 5 is a flow chart showing a process in the analog electronic clock according to the mode for carrying out the invention.

FIG. 6 is a timing chart for the analog electronic clock according to the mode for carrying out the invention.

### DETAILED DESCRIPTION OF THE PREFERRED EMBODIMENTS

A mode for carrying out the invention will now be described in detail with reference to the drawings.

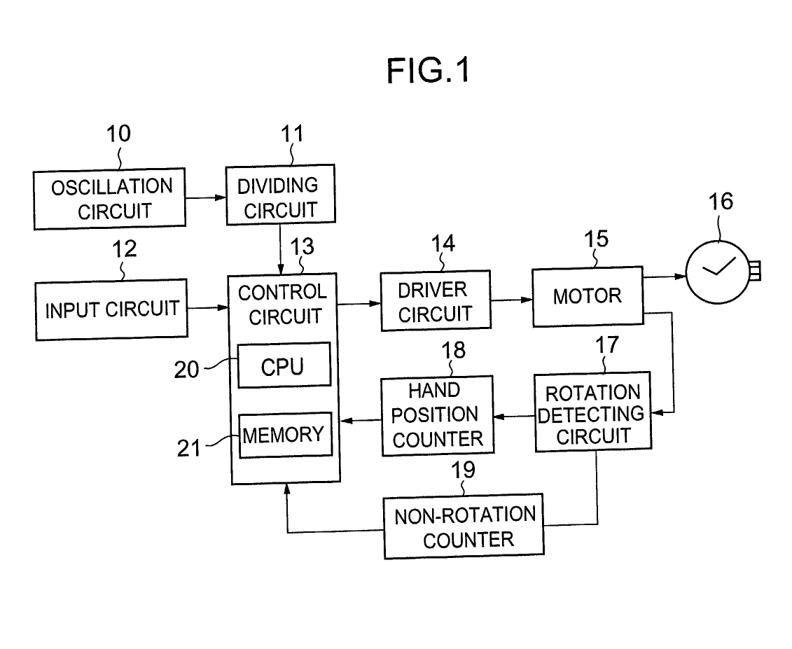

FIG. 1 is a block diagram of an analog electronic clock according to a mode for carrying out the invention, and it shows an example of an analog electronic wrist watch.

In FIG. 1, an oscillation circuit 10 is connected to a first input section of a control circuit 13 through a dividing circuit 11. An input circuit 12 is connected to a second input section of a control circuit 13. The control circuit 13 has a central processing unit (CPU) 20 and a memory 21 that is constituted by a ROM or RAM. Processing programs are stored in the memory 21, and the CPU 20 performs processes as will be described later by executing the programs. A count value representing a target position to which a hand 16 is to move is stored in the memory 21.

An output section of the control circuit 13 is connected to a motor 15 for driving the hand through a driver circuit 14. The motor 15 is a step motor that is commonly used for a clock, and it is driven for rotation by the driver circuit 14 to drive the hand 16 for rotation.

The motor 15 is connected to an input section of a rotation detecting circuit 17 for detecting the rotation of the motor 15. The rotation detecting circuit 17 is a rotation detecting circuit as well known and is configured to output a rotation detection pulse signal based on a judgment that the motor 15 has rotated when a detection signal generated at the motor 15 at the time of detection is equal to or less than a predetermined threshold each time the rotation of the motor 15 is controlled by a driving pulse and to output a non-rotation detection pulse signal based on a judgment that the motor 15 has not rotated when the threshold is exceeded.

A first output section of the rotation detecting circuit 17 is connected to a third input section of the control circuit 13 through a hand position counter 18 for counting the rotation detection pulse signal. A second input section of the rotation detecting circuit 17 is connected to a fourth input section of the control circuit 13 through a non-rotation counter 19 for counting the non-rotation detection pulse signal.

The oscillation circuit 10, the dividing circuit 11, the control circuit 13, the rotation detecting circuit 17, the hand position counter 18, the non-rotation counter 19, the CPU 20 and the memory 21 constitute the motor control means. The rotation detecting circuit 17 constitutes the detection means; the hand position counter 18 constitutes the first counting means; the non-rotation counter 19 constitutes the second counting means; and the memory 21 constitutes the first storage means for storing a count value representing the target position to which the hand 16 is to move and the second storage means for storing the value counted by the hand position counter 18 when the value counted by the non-rotation counter 19 reaches a predetermined value.

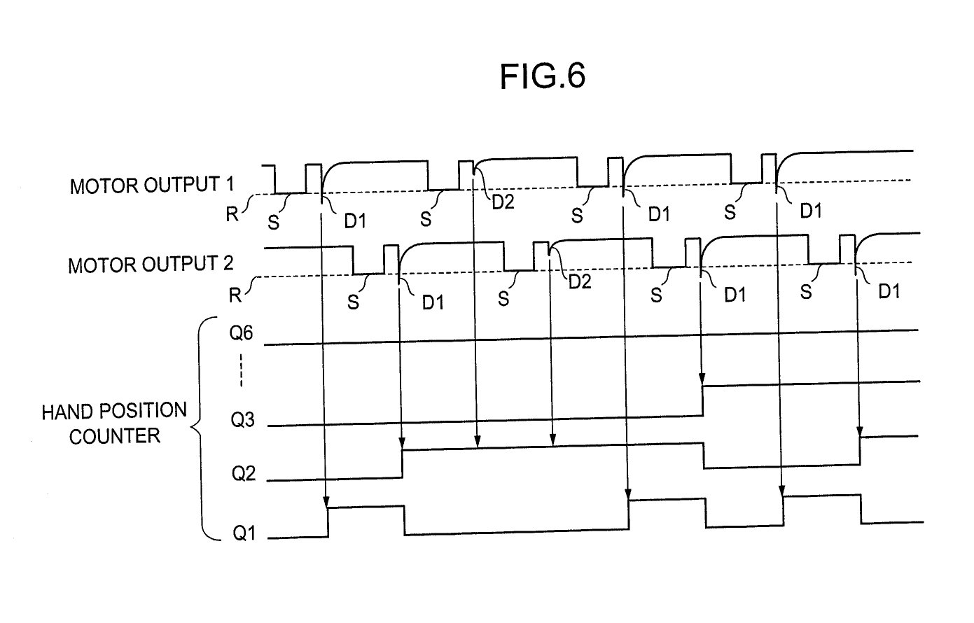

FIG. 6 is a timing chart in the present mode for carrying out the invention, the chart showing a driving pulse S supplied from the control circuit 13 to the driver circuit 14, detection signals D1, D2 generated at the motor 15 after it is driven and a value counted by the hand position counter 18. When the motor 15 has rotated, since the detection signal D1 indicating that the motor 15 has rotated (a detection signal equal to or less than a predetermined threshold R) is obtained, the rotation detecting circuit 17 detects the detection signal D1 and outputs a rotation detection pulse signal. When the motor 15 has not rotated, since the detection signal D2 indicating that the motor 15 has not rotated (a detection signal exceeding the predetermined threshold R) is obtained, the rotation detecting circuit 17 cannot detect the detection signal D1. In this case, the rotation detecting circuit 17 output a non-rotation detection pulse signal.

The hand position counter 18 counts rotation detection pulse signals from the rotation detecting circuit 17. The hand position counter 18 is constituted by a counter that is capable of counting at least 60 rotation detection pulse signals (which correspond to 60 minutes or one rotation of the hand) and is constituted by a 6-bit counter in the present mode for carrying out the invention.

The non-rotation counter 19 counts non-rotation detection pulse signals (or counts instances in which the detection signal D1 cannot be detected because motor 15 does not rotate in spite of the fact that a driving pulse is supplied), an it is constituted by a 4-bit counter in the present mode for carrying out the invention.

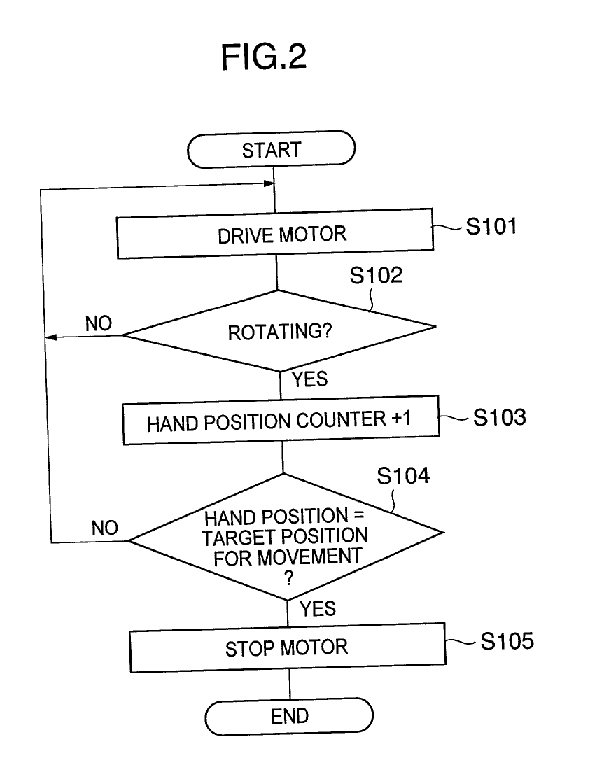

FIG. 2 is a flow chart showing a process in the present mode for carrying out the invention, and it is a flow chart showing a process in a case in which the motor 15 is driven in reverse to cause an operation of returning the hand to the position of zero hour properly.

A process of properly returning the hand to the position of zero hour will now be described using FIG. 1 and FIG. 2.

In FIG. 2, when an instruction for a return to the position of zero hour is input from an input circuit to the control circuit 13 through an operation on an operating section which is not shown (for example, a crown), the driving pulse S is supplied from the control circuit 13 to the driver circuit 14 to control the rotation of the motor 15 (step S101). The rotation detecting circuit 17 detects the rotation of the motor 15 each time the driving pulse S is supplied to the motor 15. The rotation detecting circuit 17 outputs a rotation detection pulse signal to the hand position counter 18 when it detects the rotation of the motor 15 by detecting the detection signal D1 and outputs a non-rotation detection pulse to the non-rotation counter 19 when it cannot detect the detection signal D1 and detects that the motor 15 is not rotating (step S102).

Upon receipt of the rotation detection pulse signal from the rotation detecting circuit 17, the hand position counter 18 increments its count value (step S103). When it is judged that the motor 15 is not rotating at step S102, the process returns to step S101.

Next, the CPU 20 judges whether the count value representing the target position to which the hand 16 is to move stored in the memory 21 and the value counted by the hand position counter 18 agree with each other or not, i.e., whether or not the current position of the hand agrees with the position to which it is to move (step S104). When they agree with each other, the rotation control of the motor 15 is stopped (step S105) to terminate the process. Step S104 constitutes the judging means.

When it is judged at step S104 that the count value representing the target position for movement stored in the memory 21 and the value counted by the hand position counter 18 are different, i.e., when the current position of the hand and the position to which it is to move are different, the process returns to step S101 and repeats.

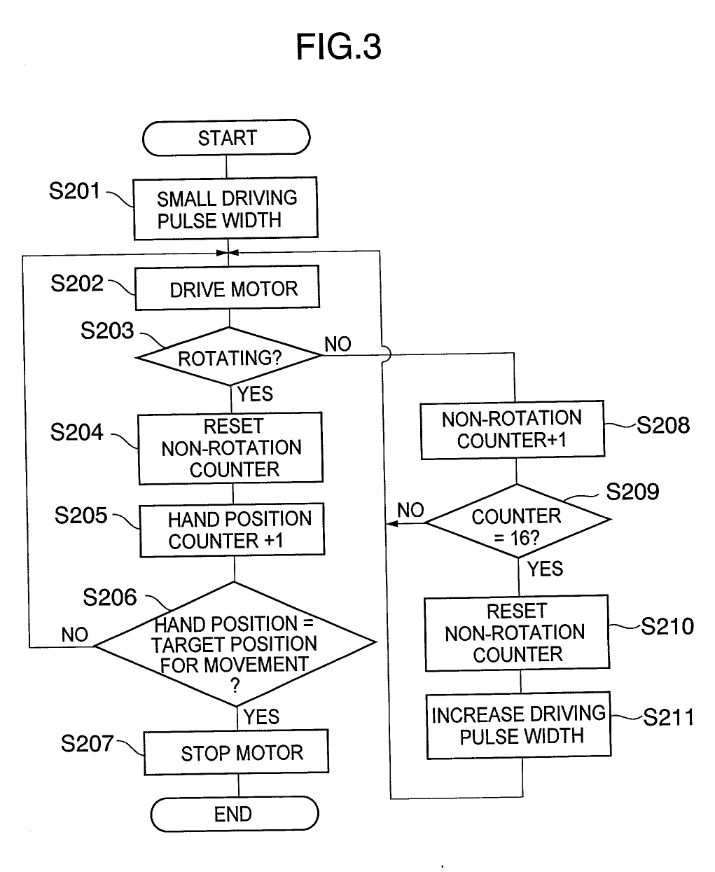

FIG. 3 is a flow chart showing a process in the present mode for carrying out the invention and is a flow chart showing a process of driving the motor 15 with a corrective driving pulse having a width greater than that of the normal driving pulse when the motor 15 does not continuously rotate predetermined times (16 times in the present mode for carrying out the invention) for some reason in spite of the fact that the normal driving pulse having a predetermined width has been supplied from the control circuit 13 to the driver circuit 14.

In FIG. 3, when an instruction for a return to the position of zero hour is input from the input circuit to the control circuit 13 through an operation on the operating section (for example, a crown), the CPU 20 sets a driving pulse having a predetermined minimum pulse width required for driving the motor 15 (a normal driving pulse) as the driving pulse to be supplied to the driver circuit 14 (step S201).

Next, the CPU 20 supplies the normal driving pulse set at step 201 to the driver circuit 14 to drive the motor 15 (step S202).

As previously described, the rotation detecting circuit 17 detects whether the motor 15 has rotated or not each time the rotation of the motor 15 is controlled by the normal driving pulse (step S203). Each time the rotation detecting circuit 17 detects that the motor 15 has rotated, it outputs a reset signal to the non-rotation counter 19 to reset the non-rotation counter 19 and outputs a rotation detection pulse signal to the hand position counter 18 (step S204). The hand position counter 18 counts the rotation detection pulse signals and adds only 1 to the count value at that point in time (step S205).

The CPU 20 judges whether the count value in the hand position counter 18 agrees with the target position for movement (step S206) or not and, if they agree with each other, it judges that the current position of the hand agrees with the target position for movement and stops controlling the rotation of the motor 15 (step S207) to terminate the process. Step S206 constitutes the judging means.

When the count value in the hand position counter 18 and the target position for movement are different at step S206, it judges that the current position of the hand has not reached the target position for movement and returns to step S202 to repeat the process.

Each time the rotation detecting circuit 17 detects that the motor 15 is not rotating (non-rotation) at step S203, it outputs a non-rotation detection pulse signal to the non-rotation counter 19. The non-rotation counter 19 counts the non-rotation detection pulse and adds only 1 to the count value at that point in time (step S208).

The CPU 20 judges whether the count value in the non-rotation counter 19 has reached a predetermined predetermined value (16 in the present mode for carrying out the invention) or not (step S209) and, if it judges that the predetermined value has not been reached, it returns to step S202. If it is judged at step S209 that the count value in the non-rotation counter 19 has reached the predetermined value, the count value in the non-rotation counter 19 is reset (step S210), and the process returns to step S202 after a driving pulse whose pulse width is greater than that of the normal driving pulse (corrective driving pulse) is set (step S211). At step S202, the motor 15 is driven with the corrective driving pulse set at step S211.

Thereafter, the process is repeated to expand the driving pulse by a predetermined width at a time until it becomes able to rotate the motor 15 and, when a corrective driving pulse capable of driving the motor 15 is set, driving is thereafter performed with the corrective driving pulse. Since driving is performed by thus expanding the pulse width of the driving pulse to set a corrective driving pulse when non-rotation is not performed continuously predetermined times, it is possible to prevent driving from being frequently performed with the corrective driving pulse.

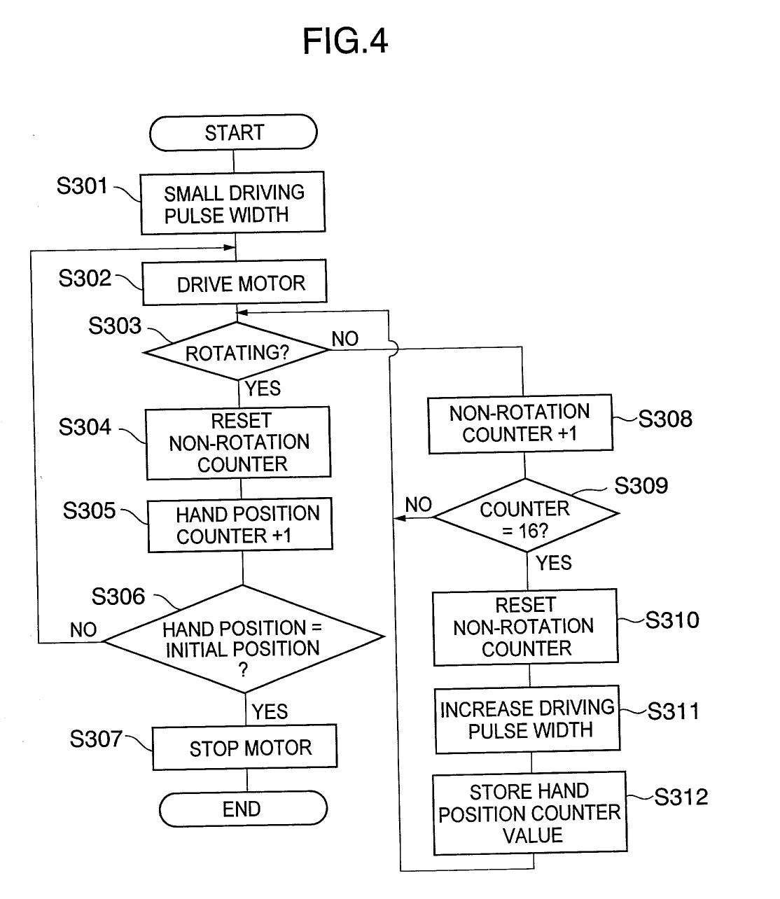

FIG. 4 is a flow chart showing a process in the present mode for carrying out the invention and is a flow chart showing an initialization process for detecting a position in which it is difficult to rotate the motor 15 with the normal driving pulse. The initialization process is performed in occasions such as a reset that occurs in the case of replacement of a battery or as a result an operation on the operating section.

In FIG. 4, when a reset occurs as a result of replacement of a battery, the CPU 20 sets the driving pulse having a predetermined minimum pulse width required for driving the motor 15 (normal driving pulse) as the driving pulse to be supplied to the driver circuit 14 (step S301).

Next, the CPU 20 supplies the normal driving pulse set at step 201 to the driver circuit 14 to drive the motor 15 (step S302).

The rotation detecting circuit 17 detects whether the motor 15 has rotated or not each time the rotation of the motor 15 is controlled with the normal driving pulse as previously described (step S303). Each time the rotation detecting circuit 17 detects that the motor 15 has rotated, it outputs a reset signal to the non-rotation counter 19 to reset the non-rotation counter 19 and outputs a rotation detection pulse signal to the hand position counter 18 (step 304). The hand position counter 18 counts the rotation detection pulse signal and adds only 1 to the count value at that point in time (step S305).

The CPU 20 judges whether the value counted by the hand position counter 18 agrees with an initial position (for example, the position of zero hour) or not, i.e., whether the hand 16 has made a revolution or not (step S306) and, if they agree, it judges that the current position of the hand agrees with the initial position and stops driving the motor 15 (step S307) to terminate the process. Step S306 constitutes the judging means.

When the count value in the hand position counter 18 and the position to move are different at step S306, it is judged that the current position of the hand has not reached the target position for movement and returns to step S301 to repeat the process.

Each time the rotation detecting circuit 17 detects that the motor 15 is not rotating (non-rotation) at step S303, it outputs a non-rotation detection pulse signal to the non-rotation counter 19. The non-rotation counter 19 counts the non-rotation detection pulse signal and increments the count value at that point in time (step S308).

The CPU 20 judges whether the count value in the non-rotation counter 19 has reached a predetermined predetermined value (16 in the present mode for carrying out the invention) or not (step S309) and returns to step S302 when it judges that the predetermined value has not been reached.

When it is judged at step S209 that the count value in the non-rotation counter 19 has reached the predetermined value, the count value in the non-rotation counter 19 is reset (step S310); a new driving pulse (corrective driving pulse) (step S311) is set by expanding the pulse width of the driving pulse by a predetermined value; and the process thereafter returns to step S302 with the count value in the hand position counter 18 stored in the memory 21 (step S312). At step S302, the motor 15 is driven with the corrective driving pulse set at step S311.

The CPU 20 judges whether the count value in the non-rotation counter 19 has reached a predetermined predetermined value (16 in the present mode for carrying out the invention) or not at step S209 (step S309) and, if it judges that the predetermined value has not been reached, it returns to step S302. If it is judged at step S309 that the count value in the non-rotation counter 19 has reached the predetermined value, the count value in the non-rotation counter 19 is reset (step S310); a driving pulse whose pulse width is greater than that of the normal driving pulse (corrective driving pulse) is set (step S311); and the process returns to step S302 with the count value in the hand position counter 18 stored in the memory 21(step S312). At step S302, the motor 15 is driven with the corrective driving pulse set at step S311.

Thereafter, a rotating position of the motor 15 where it cannot be driven with the normal driving pulse can be detected by repeating the process. In doing so, it is possible to easily find a position in which a predetermined wheel for driving the hand is difficult to rotate by setting the wheel such that it makes a revolution when the motor 15 makes a revolution.

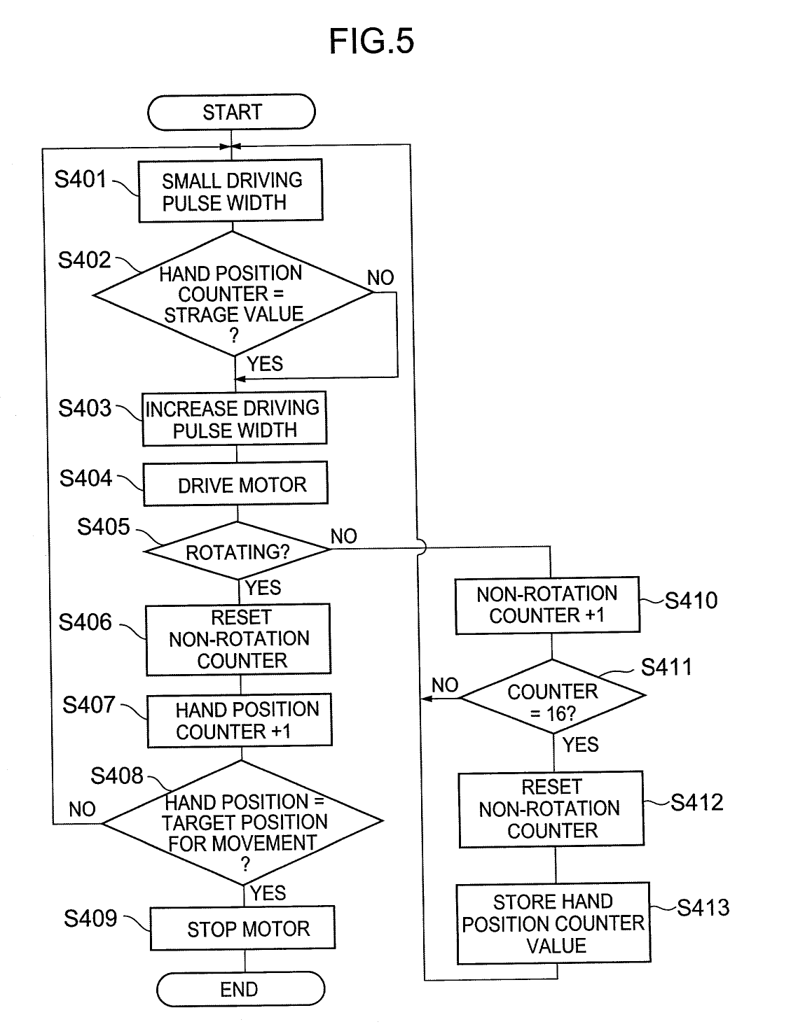

FIG. 5 is a flow chart showing a process that is normally performed during an operation of returning the hand in the present mode for carrying out the invention, the chart showing a process of driving the motor 15 by switching the driving pulse from the normal driving pulse to the corrective driving pulse in the position in which the motor 15 is difficult to rotate detected at the initialization process in FIG. 4.

In FIG. 5, when an instruction for a return to the position of zero hour is input from the input circuit to the control circuit 13 through an operation on the operating section which is not shown (for example, a crown), the CPU 20 sets a driving pulse having a predetermined minimum pulse width required for driving the motor 15 (normal driving pulse) as the driving pulse to be supplied to the motor 15 (step S401).

Next, the CPU 20 judges whether or not the count value in the hand position counter 18 agrees with the count value stored in the memory 21 as a result of the initialization process in FIG. 4, i.e., whether or not the motor 15 has reached a position in which it is difficult to rotate (step S402).

When the count value in the hand position counter 18 and the count value stored in the memory 21 do not agree with each other, the CPU 20 proceeds to step S404 to drive the motor 15 to the driver circuit 14 by supplying a driving pulse having the current pulse width and, when the values agree with each other, the driving pulse is changed to a corrective driving pulse, and the corrective driving pulse is supplied to the driver circuit 14 to drive the motor (step S404).

The rotation detecting circuit 17 detects whether or not the motor 15 has been rotated with the driving pulse each time(step S405). Each time the rotation detecting circuit 17 detects that the motor 15 has rotated, it outputs a reset signal to the non-rotation counter 19 to reset the non-rotation counter 19 and outputs a rotation detection pulse signal to the hand position counter 18 (step S406). The hand position counter 18 counts the rotation detection pulse signal and adds only 1 to the count value at that point in time (step S407).

The CPU 20 judges whether the count value in the hand position counter 18 agrees with the target position for movement (for example, the position of zero hour) or not (step S408) and, if they agree with each other, it judges that the current position of the hand agrees with the target position for movement and stops the driving of the motor 15 (step S409) to terminate the process. Step S408 constitutes the judging means.

When the count value in the hand position counter 18 and the target position for movement are different at step S408, it judges that the current position of the hand has not reached the target position for movement and returns to step S401 to repeat the process.

Each time the rotation detecting circuit 17 detects that the motor 15 is not rotating (non-rotation) at step S405, it outputs a non-rotation detection pulse signal to the non-rotation counter 19. The non-rotation counter 19 counts the non-rotation detection pulse and adds only 1 to the count value at that point in time (step S410).

The control circuit 13 judges whether the count value in the non-rotation counter 19 has reached a predetermined predetermined value (16 in the present mode for carrying out the invention) or not (step S411) and, when it is judged that the predetermined value has not been reached, the process returns to step S401. When it is judged at step S411 that the count value in the non-rotation counter 19 has reached the predetermined value, the count value in the non-rotation counter 19 is reset (step S412), and the process thereafter returns to step S401 with the count value in the hand position counter 18 stored in the memory 21 (step S413). As a result, it is possible to detect a position in which rotation is difficult to cause which has been undetectable at the initialization process in FIG. 4 and a position in which the motor 15 has become difficult to rotate because of aging and the like and to store them in the memory 21.

At step S402, it is judged whether or not the count value in the hand position counter 18 is the same as the position stored in the memory 21 at the initialization process and the position stored at step S413 and, when it is judged that the count value is equal, the motor 15 is driven for rotation with the corrective driving pulse at steps S403, 404.

Thereafter, the process is repeated to drive the motor 15 with the normal driving pulse in a position in which the motor 15 can be rotated with the normal driving pulse and to drive the motor 15 with the corrective driving pulse having a pulse width greater than that of the normal driving pulse in a position in which the motor can not be rotated with the normal driving pulse, which makes it possible to drive the motor 15 for rotation reliably.

In the case that a position in which the motor 15 is difficult to rotate is newly detected in a normal state of use and the position in which rotation is difficult is detected, since driving is performed with the corrective driving pulse when the position is reached again, rotation can be reliably caused even if the motor 15 or the wheel for driving the hand becomes difficult to rotate due to aging and the like.

As described above, the analog electronic clock according to the present mode for carrying out the invention is particularly an analog electronic clock in which the rotation of a motor 15 for driving a hand is controlled by a driving pulse supplied from motor control means and in which the hand is driven for rotation by the motor 15, characterized in that the motor control means has a memory 21 for storing a count value representing a target position to which a hand 16 is to move, a rotation detecting circuit 17 for outputting a rotation detection pulse signal each time the rotation of the motor 15 caused by the driving pulse is detected, a hand position counter 18 for counting the rotation detection pulse signal and judging means (steps S104, S206, S306, S408) for judging whether the count value stored in the memory 21 and the value counted by a hand position counter 1 have agreed with each other or not and in that the rotation of the motor 15 is controlled by the driving pulse until the count value stored in the memory 21 and the value counted by the hand position counter 18 agree with each other.

That is, since the rotation of the motor 15 itself is detected and counted by the hand position counter, it is possible to count the actual quantity of rotation of the motor 15 and to cause the hand to move to a predetermined target position reliably. It is therefore possible to allow the motor to be driven at a high speed without causing any shift in the position of the hand.

Since driving is performed with a corrective driving pulse having a greater width when a non-rotation counter 19 counts a predetermined number of consecutive non-rotation pulse signals, driving can be performed with the corrective driving pulse only in positions in such a need, which makes it possible to drive the motor 15 at a high speed.

Since a position in which the motor 15 is difficult to rotate is detected in advance at an initialization process performed at predetermined timing and the rotation of the motor 15 is controlled with the corrective driving pulse when the motor 15 rotates to reach the position, the rotation of the motor 15 can be reliably controlled.

According to the invention, a motor can be driven at a high speed without causing any shift in the position of a hand.

What is claimed is:

1. An analog electronic clock in which the rotation of a motor for driving a hand is controlled by a driving pulse supplied from motor control means and in which the hand is driven for rotation by the motor, comprising:
wherein the motor control means has storage means for storing a count value representing a target position to which the hand is to move, detection means for outputting a rotation detection pulse signal each time the rotation of the motor caused by the driving pulse is detected, first counting means for counting the rotation detection pulse signal and judging means for judging whether the count value stored in the storage means and the value counted by the first counting means have agreed with each other or not and in that the rotation of the motor is controlled by the driving pulse until the count value stored in the storage means and the value counted by the first counting means agree with each other.

2. An analog electronic clock according to claim 1, wherein the detection means further outputs a non-rotation detection pulse signal each time it is detected that the motor is not rotated by the driving pulse, and the motor control means has second counting means which counts the non-rotation detection pulse and whose count value is reset each time the detection means detects the rotation of the motor and in that:
when the value counted by the second counting means reaches a predetermined value, the control means controls the rotation of the motor with a corrective driving pulse having a width greater than a pulse width of a driving pulse which has been supplied until that point in time.

3. An analog electronic clock in which the rotation of a motor for driving a hand is controlled by a driving pulse supplied from motor control means and in which the hand is driven for rotation by the motor, comprising:
wherein the motor control means has first storage means for storing a count value representing a target position to which the hand is to move, detection means for outputting a rotation detection pulse signal each time the rotation of the motor caused by the driving pulse is detected and outputting a non-rotation detection pulse signal each time it is detected that the motor is not rotated by the driving pulse, first counting means for counting the rotation detection pulse signal, second counting means which counts the non-rotation detection pulse signal and whose count value is reset each time the detection means detects the rotation of the motor, judging means for judging whether the count value stored in the first storage means and the value counted by the first counting means have agreed with each other or not and second storage means for storing the value counted by the first counting means when the value counted by the second counting means reaches a predetermined value, in that when the value counted by the first counting means and the count value stored in the second storage means agree with each other, the rotation of the motor is controlled by a corrective driving pulse having a width greater than a pulse width of a driving pulse which has been supplied until that point in time and in that the driving of the motor is stopped when the judging means judges that the count value stored in the first storage means and the value counted by the first counting means have agreed with each other.

4. An analog electronic clock according to claim 2, further comprising:
initialization instruction means for instructing initialization at predetermined timing,
wherein the motor control means has pulse width initializing means for initializing the driving pulse to an initial driving pulse having a predetermined pulse width in response to the initialization instruction and in that the rotation of the motor is controlled by the initial driving pulse in response to the initialization instruction.

5. An analog electronic clock according to claim 3, further comprising:
initialization instruction means for instructing initialization at predetermined timing,
wherein the motor control means has pulse width initializing means for initializing the driving pulse to an initial driving pulse having a predetermined pulse width in response to the initialization instruction and in that the rotation of the motor is controlled by the initial driving pulse in response to the initialization instruction.

6. An analog electronic clock according to claim 1, further comprising:
an operating section,
wherein the motor control means controls the rotation of the motor until the count value stored in the first storage means and the value counted by the first counting means agree with each other in response to an operation on the operating section.

7. An analog electronic clock according to claim 3, further comprising:
an operating section,
wherein the motor control means controls the rotation of the motor until the count value stored in the first storage means and the value counted by the first counting means agree with each other in response to an operation on the operating section.

8. An analog electronic clock according to claim 1, further comprising:
an operating section,
wherein the motor control means controls the rotation of the motor with a driving pulse for reversing the motor until the count value stored in the first storage means and the value counted by the first counting means agree with each other in response to an operation on the operating section.

9. An analog electronic clock according to claim 1, further comprising:
an operating section,
wherein the motor control means controls the rotation of the motor with a driving pulse for reversing the motor until the count value stored in the first storage means and the value counted by the first counting means agree with each other in response to an operation on the operating section.
